(19) United States
(12) Patent Application Publication
(10) Pub. No.: US 2021/0221062 A1
(43) Pub. Date: Jul. 22, 2021

(54) PRINTERS

(71) Applicant: HEWLETT-PACKARD DEVELOPMENT COMPANY, L.P., Spring, TX (US)

(72) Inventors: Alexander David LAWS, Vancouver, WA (US); Samantha KANG, Vancouver, WA (US); Jay OSBORNE, Vancouver, WA (US)

(73) Assignee: HEWLETT-PACKARD DEVELOPMENT COMPANY, L.P., Houston, TX (US)

(21) Appl. No.: 16/075,494

(22) PCT Filed: Jun. 27, 2017
(86) PCT No.: PCT/US2017/039568

§ 371 Date: Aug. 3, 2018

(51) Int. Cl. B29C 64/35; B29C 64/25

(52) U.S. Cl. CPC B29C 64/35; B33Y 40/00; B29C 64/25

(57) ABSTRACT

Printers and associated printer maintenance methods and apparatus are disclosed. An example printer includes a build material dispenser to dispense build material onto a work area; a contaminant filter to receive at least some of the build material from the work area, the contaminant filter being structured to filter contaminants from the build material received; and a drawer including the contaminant filter, the drawer to enable the contaminant filter to be removed for cleaning.

### BACKGROUND

Additive manufacturing systems may be used to produce three-dimensional objects. In some examples, the three-dimensional objects are produced in layers using build material.

### BRIEF DESCRIPTION OF THE DRAWINGS

FIG. 1 is a schematic illustration of an example printer in accordance with the teachings of this disclosure.

FIG. 2 is a schematic illustration of the example maintenance procedure controller of FIG. 1.

FIG. 3 is an isometric view of an example build material recovery system that can be used to implement the example build material recovery system of FIG. 1.

FIG. 4 is another isometric view of the example build material recovery system of FIG. 3 with an example drawer in an open position.

FIG. 5 is a detailed view of an example latch assembly of the example build material recovery system of FIG. 3.

FIG. 6 shows the example latch assembly of the example build material recovery system of FIG. 3 moving from a closed position to an open position.

FIG. 7 shows the example latch assembly of the example build material recovery system of FIG. 3 moving from an open position to a closed position.

FIG. 8 is a detailed view of the example vacuum system of the example build material recovery system of FIG. 3.

FIG. 9. a flowchart representative of machine readable instructions that may be executed to implement the example maintenance procedure controller of FIG. 2.

FIG. 10 is another flowchart representative of machine readable instructions that may be executed to implement the example maintenance procedure controller of FIG. 2.

FIG. 11 is a processor platform structured to execute the instructions of FIGS. 9 and 10 to implement the maintenance procedure controller of FIG. 2.

The figures are not to scale. Wherever possible, the same reference numbers will be used throughout the drawing(s) and accompanying written description to refer to the same or like parts. While the drawings illustrate examples of printers and associated printer maintenance methods and apparatus, other examples may be employed to implement the examples disclosed herein.

### DETAILED DESCRIPTION

The examples disclosed herein relate to removing contaminants from build material and/or powder used in connection with additive manufacturing systems (e.g., three-dimensional (3-D) printers). In some examples, to separate the contaminants (e.g., large contaminant particles) from the remainder of the build material and/or powder, a screening process takes place where the build material passes through the screen into a hopper and the contaminants are captured on the top of the screen. As the contaminants collect on the screen, the mass flow rate through the screen may be reduced. Thus, the screen may be cleaned during routine maintenance (e.g., every week, every month, etc.) to increase the flowrate through the screen.

To enable collected contaminants to be easily removed from the example additive manufacturing systems in an efficient and/or non-messy manner, in some examples, example printers include an example vacuum system and an associated vibratory screen system that encourages contaminants to be moved toward the vacuum system and out of the printer. In some examples, the vacuum system includes an example port (e.g., a vacuum port) structured to be coupled to a vacuum source that draws the contaminants from the screen without the screen being physically removed from the printer. In some examples, a spring-biased cover covers the port when the port is not coupled to a vacuum. In other examples, the printer includes the vacuum source. Thus, when the printer includes the vacuum source, the contaminants may be removed automatically from a printer without an individual interacting with and/or coming in direct contact with the contaminants, the build material and, more generally, the powder. In such examples, the port may be selectively closed when a cleaning and/or maintenance operation is not taking place.

To encourage contaminants to be removed from the screen, in some examples, the vibratory screen system vibrates the screen to move and/or drive the contaminants toward the vacuum and/or to break any coupling between the contaminant and the screen. To enable the screen to be removed for further cleaning and/or maintenance, in some examples, the screen and the associated vibratory screen system are coupled to a user-accessible drawer. In such examples, the vibratory screen system may be incorporated into the drawer itself.

In some examples, to form a container and/or screen box into which the contaminants are collected, the screen covers an end (e.g., the bottom) of a frame. To enable the screen and the associated frame to be actuated, in some examples, the example drawer includes an actuator. In some examples, the actuator is an electromagnet mounted between the screen box and the drawer frame. Thus, in such examples, the screen box is responsive to the electromagnet being actuated (e.g., pulsed, oscillated). However, any other suitable actuator may be used such as, for example, a motor with an offset mass, etc. To enable the screen and the associated frame to be moved when being actuated, in some examples, springs couple the screen box to an example drawer frame. The springs may be coupled at the corners of the screen box. However, the screen box may be coupled to drawer frame in any other suitable way including coupling the springs at other and/or additional locations other than the corners of the screen box.

In some examples, to deter the drawer from moving relative to a hopper beneath the filter when the drawer is in a closed position, the drawer is structured to seal against and/or lock relative to the hopper. The hopper may be used to collect build material that passes through the filter. In some examples, the example printers include an over-center latching system to encourage the coupling between the drawer and the hopper and/or to deter the drawer from moving relative to the hopper when the drawer is in the closed position. In some examples, the hopper includes opposing slots and/or tracks that receive the drawer. In some such examples, the drawer is removable by pulling the drawer out of the slots and/or may be closable by pushing the drawer into the slots. In other words, the example latch encourages the drawer to seal against the hopper when the drawer is in the closed position and is structured to enable the drawer to be easily removed from the hopper and/or printer during a maintenance events, for example.

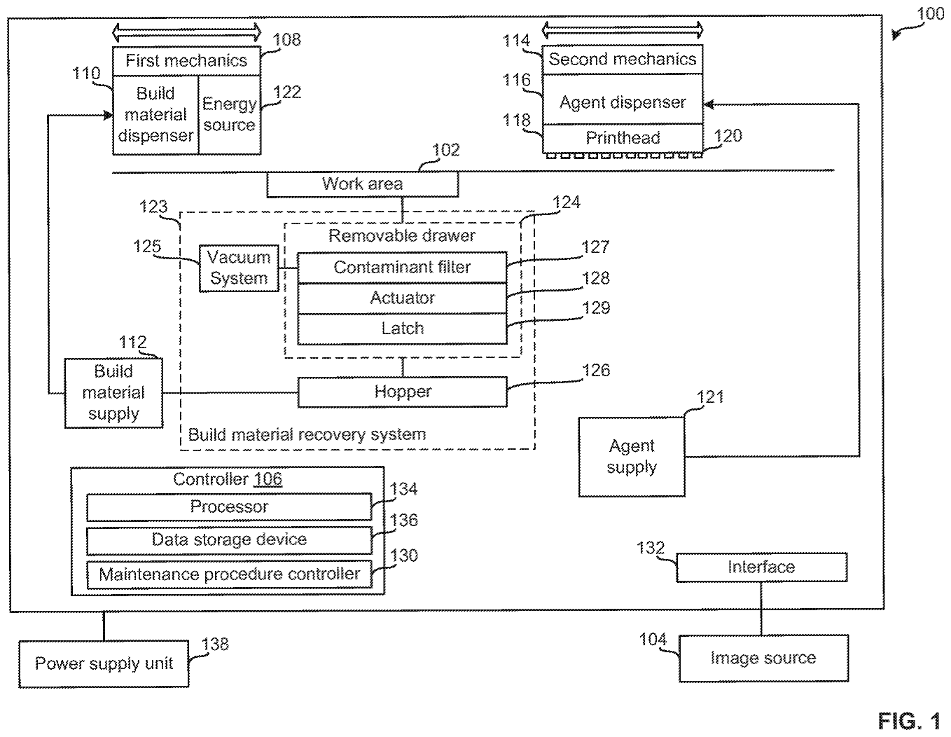

FIG. 1 is a block diagram of an example printer 100 that can be used to implement the teachings of this disclosure. The printer 100 of FIG. 1 is implemented as a 3D printer that may be used to generate objects, parts, etc. To generate an object on an example work area (e.g., a bed) 102, in the illustrated example, the printer 100 includes an image source 104 from which the printer 100 receives an image(s) and/or other data (e.g., a file) describing the object(s) to be produced on the work area 102.

To produce the object(s) on the work area 102 based on the image(s) and/or other data describing the object, an example controller 106 causes example first mechanics 108 to move an example build material dispenser 110 relative to the work area 102 to dispense a layer(s) of build material on the work area 102. In some examples, the build material dispenser 110 includes a wiper, a roller, etc. to distribute and/or dispense the build material on the work area 102. In the illustrated example, the build material is accessed from an example build material supply 112.

To enable the build material to be selectively fused and/or coupled to form the object(s), the controller 106 causes example second mechanics 114 to move an example agent dispenser 116 including an associated example printhead 118 and nozzles 120 relative to the work area 102 and overtop of the layer of build material. In some examples, the nozzles 120 selectively deposit agent on the build material as the nozzles 120 are moved by the second mechanics 114. In the illustrated example, the agent dispenser 116 and/or the printhead 118 draws and/or accesses the agent from an example agent supply 121. The agent supply 121 may include a chamber(s) (e.g., 1, 2, 3, etc.) that houses an agent(s) (e.g., 1, 2, 3, 4 types of agents) and/or another liquid(s) used during the additive manufacturing process. In some examples, the agent includes a fusing agent, a detailing agent, an agent(s) associated with accuracy and/or detail, an agent(s) associated with opacity and/or translucency and/or an agent(s) associated with surface roughness, texture and/or friction. Additionally or alternatively, in some examples, the agent includes an agent(s) associated with strength, elasticity and/or other material properties, an agent(s) associated with color (e.g., surface and/or embedded) and/or an agent(s) associated with electrical and/or thermal conductivity.

In the illustrated example, to selectively fuse and/or solidify the build material where the agent has been applied to the build material, the controller 106 causes the first mechanics 108 to move an example energy source 122 relative to the work area 102 and apply energy to the build material on the work area 102. The energy source 122 may apply any type of energy to selectively cause the build material to fuse and/or solidify. For example, the energy source 122 may include an infra-red (IR) light source, a near infra-red light source, a laser, etc. While the energy source 122 is illustrated in FIG. 1 as being positioned adjacent the build material dispenser 110 and moved by the first mechanics 108, in other examples, the energy source 122 may be positioned adjacent the agent dispenser 116 and moved by the second mechanics 114. In other examples, the energy source 122 may be moved by dedicated mechanics and/or stationarily disposed relative to the work area 102.

During the process of forming the object(s) on the work area 102, not all of the build material deposited by the build material dispenser 110 may be used to form the object. Thus, in some examples, excess and/or unused build material is recycled and/or reintroduced into the build material supply 112. In the illustrated example, prior to reintroducing the build material into the build material supply 112, the build material travels through an example material recover system 123 including an example drawer 124, an example vacuum system 125 and an example hopper 126. In this example, the drawer 124 includes an example contaminant filter 127, an example actuator 128 and an example latch 129. In some examples, the latch 129 is structured to secure the drawer 124 in place relative to the hopper 126 and/or to discourage movement of the drawer 124 relative to the build material supply 112 regardless of movement of the contaminant filter 127.

In practice, as the printer 100 generates objects, parts, etc., the unused build material travels through the contaminant filter 127 and the contaminants accumulate on the filter 127. Some contaminants may include larges particles and/or clumps of the build material and/or debris that are introduced into the build material (e.g., hair, sweater particles, etc.).

To enable the accumulated contaminants to be removed from the contaminant filter 127, the example printer 100 includes the example vacuum system 125. In some examples, the vacuum system 125 is implemented as a port that is structured to be coupled to a vacuum (e.g., a wet/dry vacuum) that sucks the accumulated contaminants from the contaminant filter 127. To encourage the accumulated contaminants to move toward the vacuum system 125, the example actuator 128 actuates the contaminant filter 127. In some examples, the actuator 128 is implemented as an electromagnet that is structured to actuate and/or oscillate the contaminate filter 127.

In the illustrated example, the controller 106 includes an example maintenance procedure controller 130 to determine when to perform a maintenance event. In some examples, the maintenance procedure controller 130 determines to perform a maintenance event after a threshold amount of time has elapsed, after a threshold number of object(s) have been built, after a threshold amount of build material has been used, etc. Regardless of why the maintenance procedure controller 130 determines to perform a maintenance event, in some examples, during the maintenance event, the maintenance procedure controller 130 causes a notification to be generated and/or provided to a maintenance scheduling system and/or to an operator tasked with performing maintenance on the printer 100. Additionally or alternatively, when the maintenance procedure controller 130 determines to perform a maintenance event, the maintenance procedure controller 130 causes a maintenance event to be scheduled an a calendar. In some examples, when a maintenance event is occurring, the maintenance procedure controller 130 determines that a vacuum is coupled to the vacuum system 125 and/or causes the actuator 128 to actuate the contaminant filter 127 for a threshold amount of time.

The example printer 100 of FIG. 1 includes an interface 132 to interface with the image source 104. The interface 132 may be a wired or wireless connection connecting the printer 100 and the image source 104. The image source 104 may be a computing device from which the printer 100 receives data describing a task (e.g., an object to form, a print job, etc.) to be executed by the controller 106. In some examples, the interface 132 facilitates the printer 100 and/or a processor 134 to interface with various hardware elements, such as the image source 104 and/or hardware elements that are external and/or internal to the printer 100. In some examples, the interface 132 interfaces with an input or output device, such as, for example, a display device, a mouse, a keyboard, etc. The interface 132 may also provide access to other external devices such as an external storage device, network devices, such as, for example, servers, switches, routers, client devices, other types of computing devices and/or combinations thereof.

The example controller 106 includes the example processor 134, including hardware architecture, to retrieve and execute executable code from an example data storage device 136. The executable code may, when executed by the example processor 134, cause the processor 134 to implement at least the functionality of controlling the first mechanics 108 and/or the build material dispenser 110 to dispense build material on the work area 102, the second mechanics 114 and/or the agent dispenser 116 including the associated printhead 118 and the nozzles 120 to dispense the agent onto the build material and/or the first mechanics 108 and/or the energy source 122 to apply energy to the build material on the work area 102 to form the object(s). The executable code may, when executed by the example processor 134, cause the processor 134 to provide instructions to an example power supply unit 138, to cause the power supply unit 138 to provide power to the example printhead 118 to eject a liquid from the example nozzle(s) 120.

The data storage device 136 of FIG. 1 stores instructions that are executed by the example processor 136 or other processing devices. The example data storage device 136 may store computer code representing a number of applications, firmware, machine readable instructions, etc. that the example processor 134 executes to implement the examples disclosed herein,

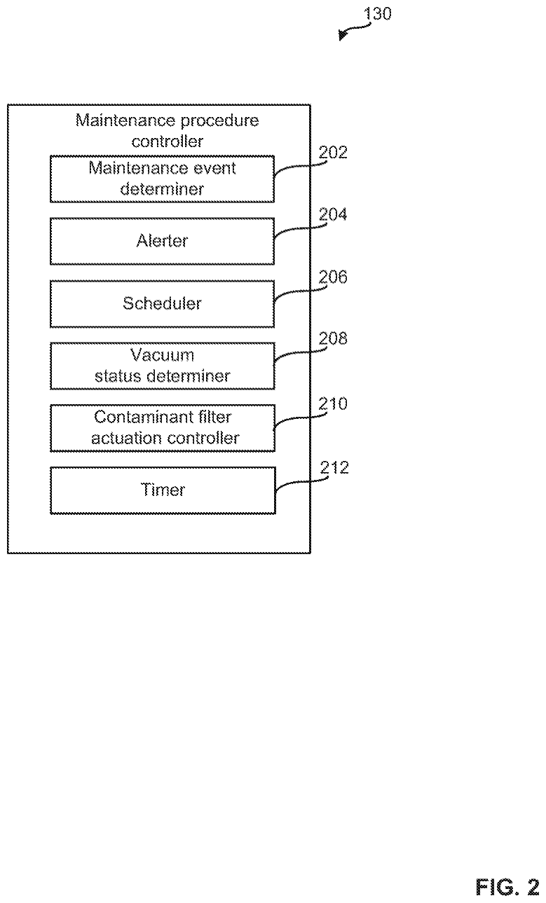

FIG. 2 illustrates an example implementation of the maintenance procedure controller 130 of FIG. 1. As shown in the example of FIG. 2, the maintenance procedure controller 130 includes an example maintenance event determiner 202, an example alerter 204, an example scheduler 206, an example vacuum status determiner 208, an example contaminant filter actuation controller 210 and an example timer 212.

In the illustrated example, to determine when to perform a maintenance event, the maintenance event determine 202 determines if a threshold amount of time has elapsed, if a threshold amount of agent has been dispensed from the nozzles 120, if a threshold amount of build material has been distributed by the build material dispenser 110 and/or if a threshold number of objects have been produced and, more generally, if a threshold amount of contaminant has accumulated within the printer 100 and/or on the contaminant filter 127. While some reasons for performing a maintenance event are disclosed, a maintenance event may be performed for any other reason. In some examples, when the maintenance event determiner 202 determines that a maintenance is to be performed, the alerter 204 generates a notification regarding maintenance to be performed and/or the scheduler 206 adds an event to a calendar regarding the maintenance event. In some examples, the maintenance event includes removing contaminants from the contaminant filter 127 using the vacuum system 125 and/or by physically removing the drawer 124 from the printer 100 to dispose of the accumulated contaminants.

In some examples, when a maintenance event begins, the vacuum status determiner 208 determines whether a vacuum is coupled to the vacuum system 125 and/or determines that a vacuum is drawing accumulated contaminant from the contaminant filter 127. When the vacuum status determiner 208 identifies a vacuum as being present and/or a maintenance event as taking place, the contaminant filter actuation controller 210 causes the contaminant filter 127 to actuate and/or move to encourage contaminants to become dislodged from the contaminant filter 127 and/or to encourage any contaminants spaced from the vacuum system 125 to move toward the vacuum system 125 to encourage its evacuation and/or removal from the drawer 124. In some examples, while contaminant filter actuation controller 210 causes the contaminant filter 127 to oscillate, the timer 212 monitors an amount of time that has elapsed since the maintenance event began. In some examples, the maintenance procedure controller 130 ends the maintenance event once the amount of time satisfies a threshold and/or once the contaminants are removed and/or substantially removed from the contaminant filter 127.

While an example manner of implementing the maintenance procedure controller 130 of FIG. 1 is illustrated in FIG. 2, the element(s), process(es) and/or device(s) illustrated in FIG. 2 may be combined, divided, re-arranged, omitted, eliminated and/or implemented in any other way. Further, the example maintenance event determiner 202, the example alerter 204, the example scheduler 206, the example vacuum status determiner 208, the example contaminant filter actuation controller 210, the example timer 212 and/or, more generally, the example maintenance procedure controller 130 of FIG. 1 may be implemented by hardware, software, firmware and/or any combination of hardware, software and/or firmware. Thus, for example, any of the example maintenance event determiner 202, the example alerter 204, the example scheduler 206, the example vacuum status determiner 208, the example contaminant filter actuation controller 210, the example timer 212 and/or, more generally, the example maintenance procedure controller 130 of FIG. 1 could be implemented by analog or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example maintenance event determiner 202, the example alerter 204, the example scheduler 206, the example vacuum status determiner 208, the example contaminant filter actuation controller 210, the example timer 212 and/or, more generally, the example maintenance procedure controller 130 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware. Further still, the example maintenance procedure controller 130 of FIG. 1 may include an element(s), process(es) and/or device(s) in addition to, or instead of, those illustrated in FIG. 2, and/or may include more than one of any or all of the illustrated elements, processes and devices.

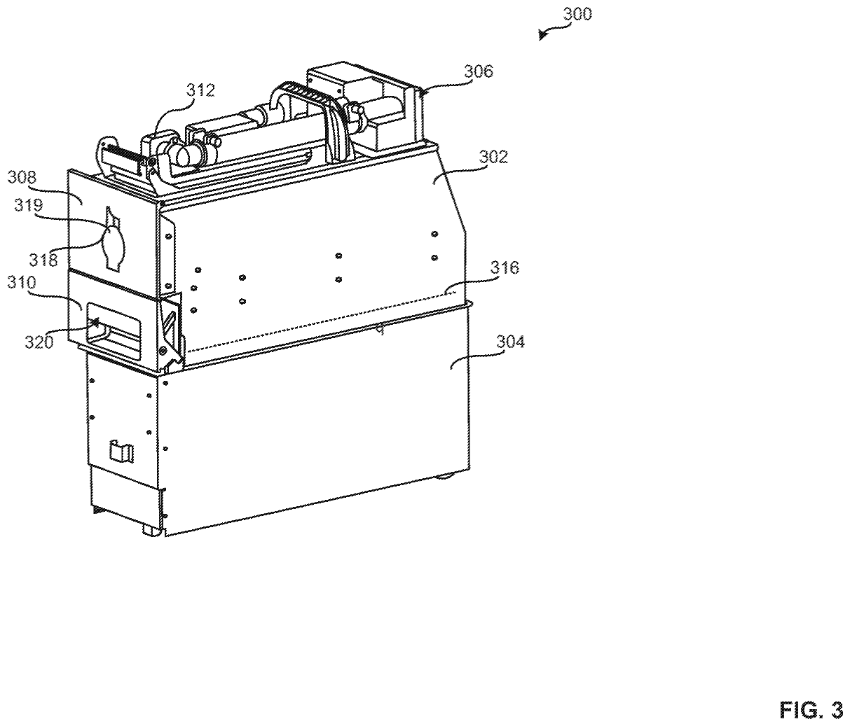

FIG. 3 illustrates an isometric view of an example build material recovery system 300 that can be used to implement the material recovery system 123 of FIG. 1. In the illustrated example, the build material recovery system 300 includes a first portion 302 and a second portion and/or hopper 304. In this example, the first portion 302 includes an inlet 306, that receives build material from the work area 102 of FIG. 1, an example vacuum system 308 that can be used to implement the example vacuum system 125 of FIG. 1 and an example drawer 310 that can be used to implement the example drawer 124 of FIG. 1.

In practice, when objects, parts, etc. are being produced, the build material recovery system 300 draws unused build material into the inlet 306 and toward a separator 312 that causes the build material to separate from air being exhausted from the build material recovery system 300. In some examples, at the separator 312, the build material is deposited onto an example screen 316 of the drawer 310. In the illustrated example, the screen 316 is used to filter contaminants from the build material entering the build material recovery system 300 and to enable build material that substantially does not include contaminants to be delivered to the hopper 304 for later use.

To enable contaminants to be removed from the screen 316 without disassembling the build material recovery system 300, the vacuum system 308 includes an example port and/or outlet 318 that is structured to be coupled to a vacuum (e.g., a wet/dry vacuum). In some examples, a spring-biased cover 319 covers the port 318 to deter inadvertent access to the port 318. To enable the drawer 310 to be securely coupled within the build material recovery system 300 and/or to deter movement between the drawer 310 and the hopper 304, the drawer 310 includes an example latch assembly 320.

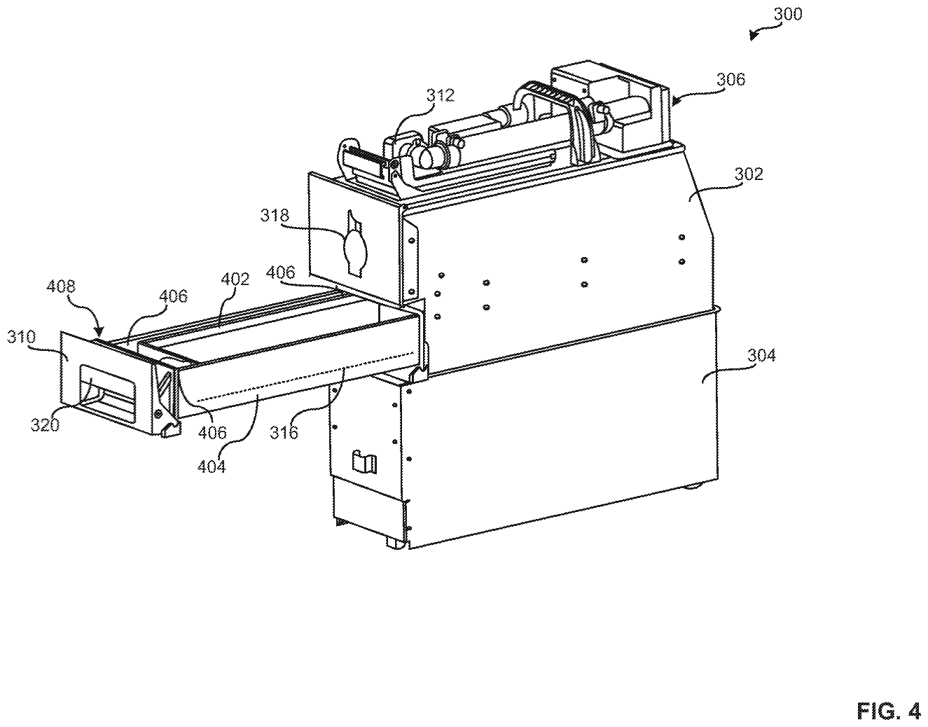

FIG. 4 illustrates another view of the example build material recover system 300 of FIG. 3 with the drawer 310 substantially removed from the first portion 302. In this example, the drawer 310 includes an example screen box 402 including the screen 316 that forms a compartment to collect contaminants. To enable the screen box 402 to move and/or oscillate and, more generally, to not be rigidly coupled within the drawer 310, the screen box 402 is coupled to a frame 404 of the drawer 310 via springs 406. In some examples, the springs 406 are coupled between each of the corners of the screen box 402 and the frame 404. However, any number of springs and/or other biasing elements may be used that are placed in any location to facilitate non-rigid coupling between the screen box 402 and the frame 404.

In the example of FIG. 4, to enable the screen box 402 to be actuated and/or to encourage contaminants to move toward the port 318 during a maintenance event, the drawer 310 includes an example actuator 408. In some example, the actuator 408 is an electromagnet mounted between the screen box 402 and the drawer frame 404 and/or a motor with an offset mass. Regardless of how the actuator 408 is implemented, the screen box 402 is responsive to the actuator 408 to move contaminants toward the port 318 and/or dislodge contaminants from the screen 316 during a maintenance event and/or otherwise,

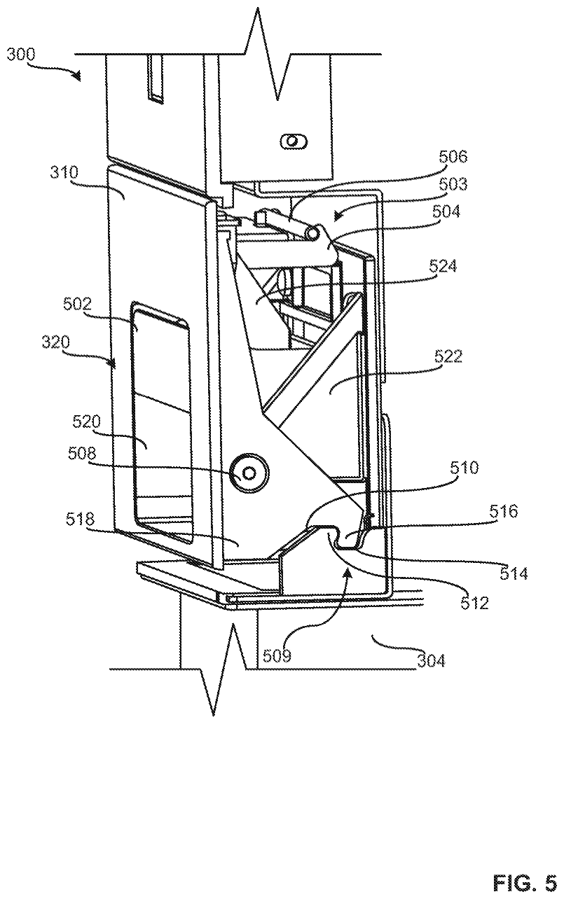

FIG. 5 illustrates a detailed view of the example latch assembly 320 of the example build material recovery system 300 of FIG. 3. In this example, the latch assembly 320 includes an externally accessible handle 502 that, when actuated, disengages a first coupling 503 to enable the latch assembly 320 to move about a pivot 508. In some examples, the first coupling 503 includes an example latch 504 that moves out of engagement with a bar and/or catch 506 when the handle 502 is actuated.

In the example of FIG. 5, moving the latch assembly 320 about the pivot 508 disengages a second coupling 509 to enable the drawer 310 to be removed from the build material recovery system 300. In some examples, the second coupling 509 includes a first notch 510 of the latch assembly 320 receiving a first protrusion 512 of the build material recovery system 300 and a second notch 514 of the build material recovery system 300 receiving a second protrusion 516 of the latch assembly 320. To guide the movement of latch assembly 320 between the secured position that retains the drawer 310 within the build material recovery system 300 and a disengaged position that enables the drawer 310 to be removed from the build material recovery system 300, the latch assembly 320 includes sides 518, 520 that interact with corresponding first and second guides 522, 524 of the build material recovery system 300.

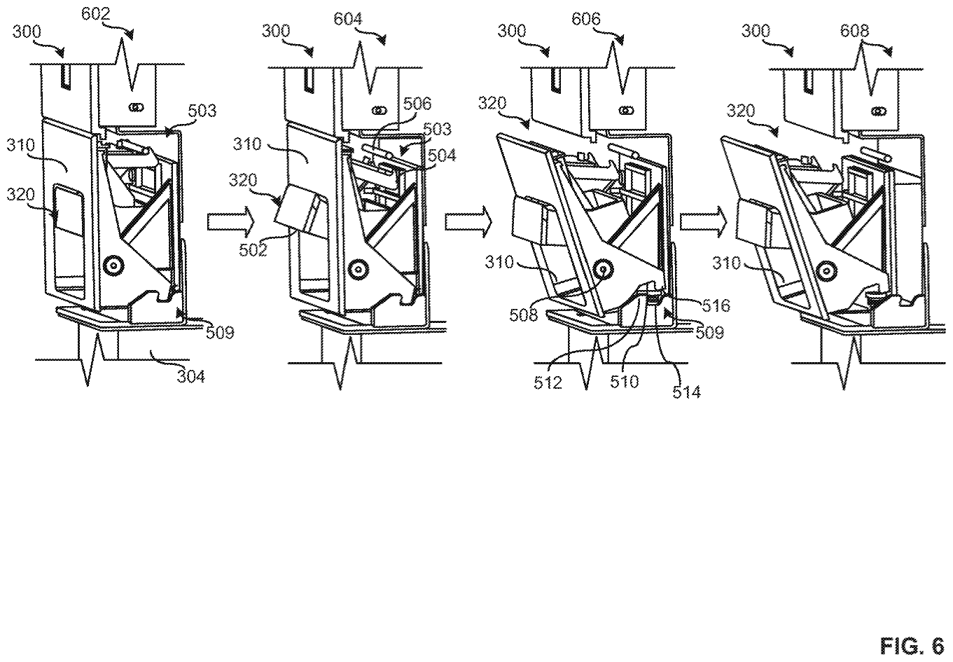

FIG. 6 illustrates a flow diagram of the latch assembly 320 being moved to the disengaged and/or unsecured position to enable the drawer 310 to be removed from the build material recovery system 300. At reference number 602, the first and second couplings 503, 509 are in the secured position deterring movement between the drawer 310 and the hopper 304 of the build material recovery system 300. At reference number 604, the handle 502 is in a lifted position that disengages the latch 504 from the bar 506 and, thus, disengages the first coupling 503. At reference number 606, the latch assembly 320 is pivoted about the pivot 508 to disengage the first and second notches 510, 514 from the first and second protrusions 512, 516 and, thus, to disengage the second coupling 509. Reference number 608 illustrates the drawer 310 being removed from the build material recovery system 300.

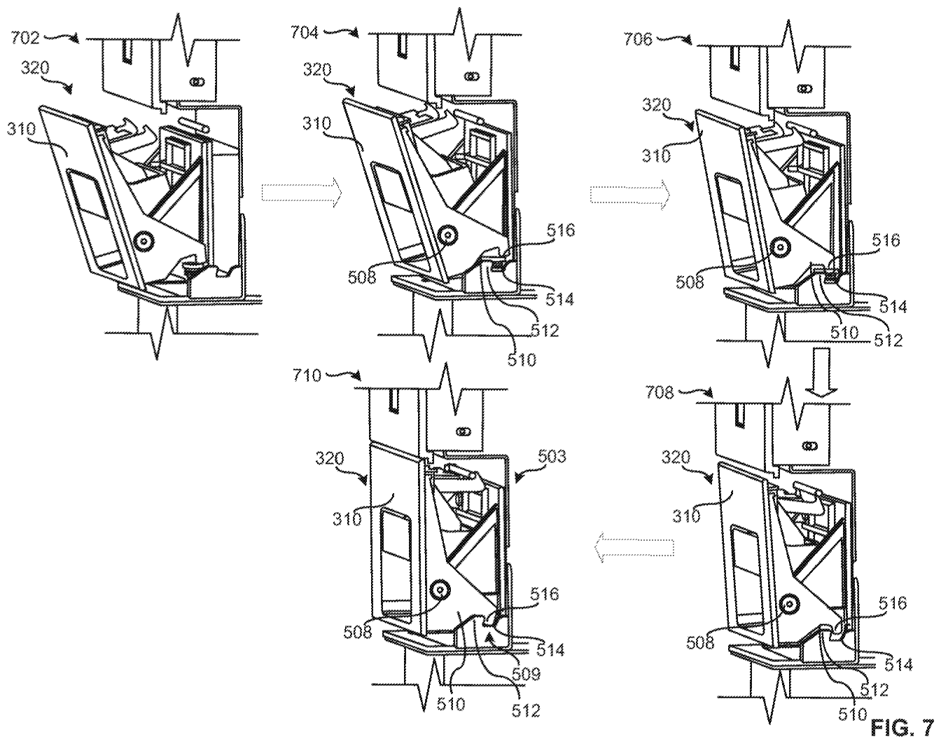

FIG. 7 illustrates a flow diagram of the latch assembly 320 being moved to the engaged and/or secured position to enable the drawer 310 to be secured within the build material recovery system 300. At reference number 702, the drawer 310 is in a withdrawn position and/or is not positioned fully within the build material recovery system 300. At reference numbers 704, 706, 708, the latch assembly 320 is being pivoted about the pivot 508 to position the second protrusion 516 within the second notch 514 and to position the first protrusion 512 within the first notch 510 to form the second coupling 509. Reference number 710 illustrates the latch 504 engaging the bar 506 and, thus, securing the drawer 310 within the material recovery system 300 via both the first coupling 503 and the second coupling 509.

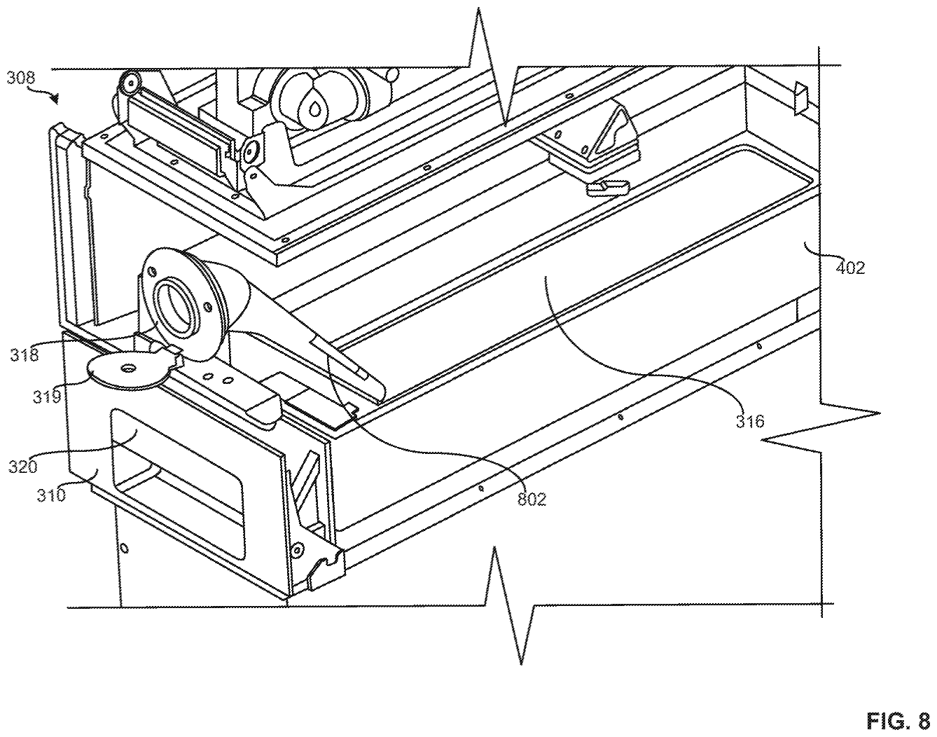

FIG. 8 illustrates a detailed view of the example vacuum system 308 and the drawer 310. As shown in the example of FIG. 8, the cover 319 being in the open position enables access to the port 318. In operation, in some examples, a vacuum is coupled to the port 318 to enable contaminants to be removed from the screen box 402 via an example nozzle 802 that is coupled to the port 318. In this example, the nozzle 802 has a width that substantially corresponds to a width of the screen box 402 to encourage contaminants to be drawn out of the screen box 402.

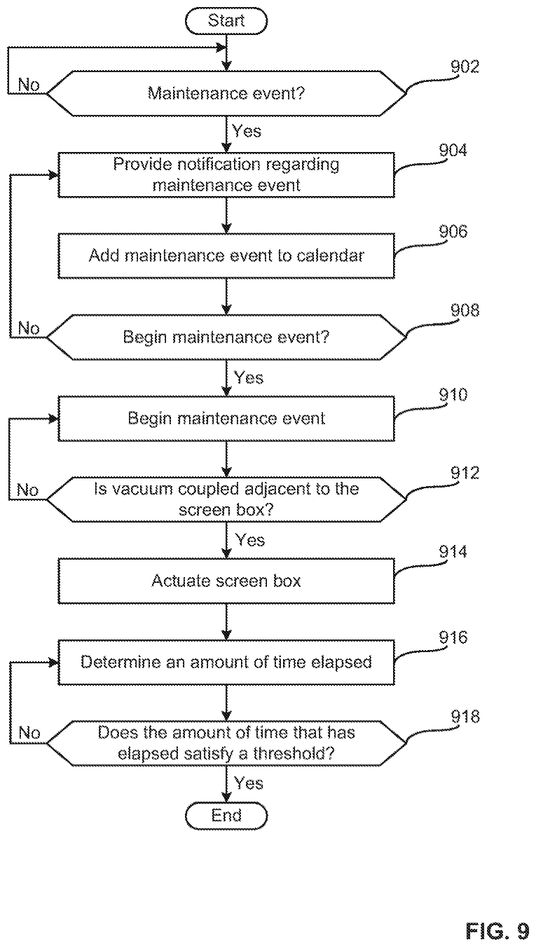

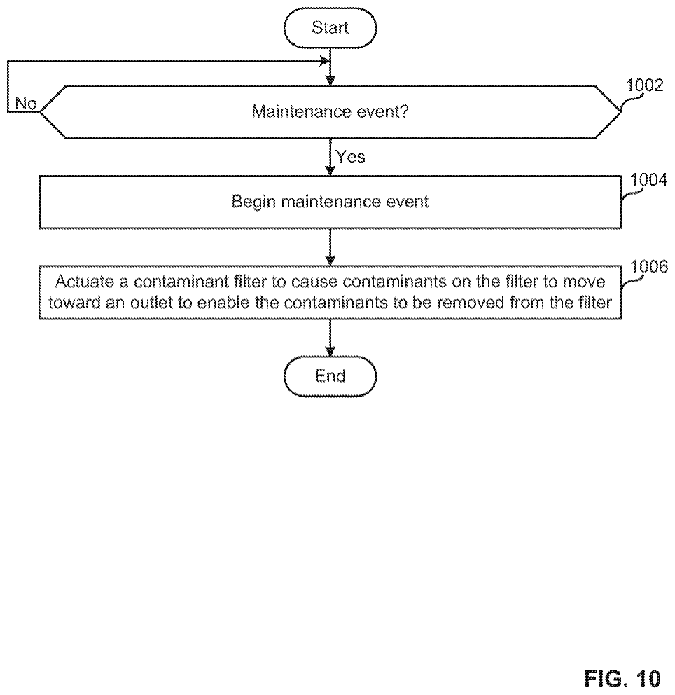

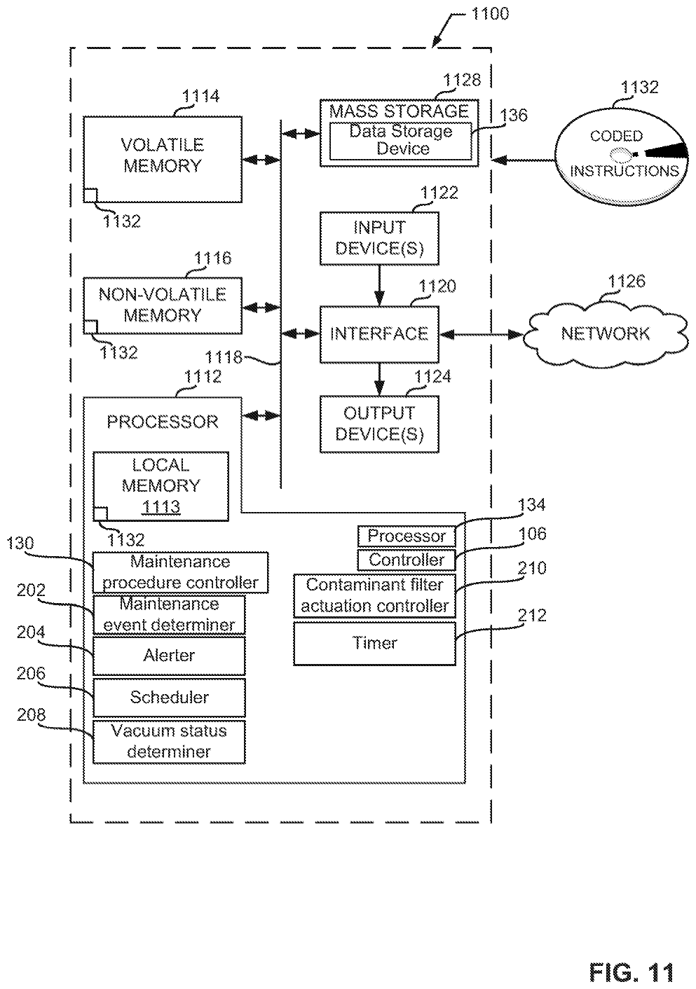

A flowchart representative of example machine readable instructions for implementing the maintenance procedure controller 130 of FIG. 2 is shown in FIGS. 9 and 10. In this example, the machine readable instructions comprise a program for execution by a processor such as the processor 1112 shown in the example processor platform 1100 discussed below in connection with FIG. 11. The program may be included in and/or implemented by software stored on a non-transitory computer readable storage medium such as a CD-ROM, a floppy disk, a hard drive, a digital versatile disk (DVD), a Blu-ray disk, or a memory associated with the processor 1112, but the entire program and/or parts thereof could alternatively be executed by a device other than the processor 1112 and/or included in and/or implemented by firmware or dedicated hardware. Further, although the example program is described with reference to the flowcharts illustrated in FIGS. 9 and 10, many other methods of implementing the example maintenance procedure controller 130 may alternatively be used. For example, the order of execution of the blocks may be changed, and/or some of the blocks described may be changed, eliminated, or combined. Additionally or alternatively, any or all of the blocks may be implemented by a hardware circuit(s) (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example processes of FIGS. 9 and 10 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

The program of FIG. 9 begins at block 902 with the maintenance event determiner 202 determining if a maintenance event should occur (block 902). In some examples, the maintenance event determiner 202 determines that a maintenance event should occur if a threshold amount of time has elapsed, if a threshold amount of agent has been dispensed from the nozzles 120, if a threshold amount of build material has been distributed by the build material dispenser 110 and/or if a threshold number of objects have been produced by the printer 100 and, more generally, if a threshold amount of contaminant has accumulated within the printer 100.

If the maintenance event determiner 202 determines to perform a maintenance event, the alerter 204 generates a notification to notify and/or alert an operator and/or individual that a maintenance event is to be performed on the printer 100 (block 904). Further, if the maintenance event determiner 202 determines to perform a maintenance event, the scheduler 206 adds a maintenance event to a calendar (e.g., a printer maintenance calendar) that schedules when an operator and/or individual is to perform a maintenance event on the printer 100 (block 906). In some examples, the scheduler 206 schedules the maintenance event at a time that substantially ensures that preventative maintenance is timely performed on the printer 100 to increase the useful life of the printer 100, etc.

At block 908, the maintenance procedure controller 130 determines whether the maintenance event is to begin (block 908). In some examples, the maintenance event begins after the printer 100 and/or the maintenance procedure controller 130 receives an input from an operator and/or individual and/or when the time for the scheduled maintenance event occurs. In some examples, the printer 100 and/or the maintenance procedure controller 130 automatically begins the maintenance event based on the scheduled maintenance event and/or some other trigger. In some such examples, the printer 100 includes a vacuum that is coupled (e.g., selectively coupled) to the contaminant filter 127 to enable contaminants to be removed from the contaminant filter 127 and/or to be removed from the screen 316 without an operator and/or an individual coupling a vacuum to a port 318 of the vacuum system 125.

If the maintenance procedure controller 130 determines to perform a maintenance event, the maintenance event begins (block 910) and the vacuum status determiner 208 determines whether a vacuum is coupled adjacent to the screen box 402 (block 912). In some examples, the vacuum status determiner 208 determines that a vacuum is coupled adjacent to the screen box 402 based on a proximity sensor and/or other sensor sensing the coupling between the port 318 and a vacuum hose. In other examples, the vacuum status determiner 208 determines that a vacuum is coupled adjacent to the screen box 402 based on an input received from an individual and/or operator at the printer 100. In other examples, the vacuum status determiner 208 determines that a vacuum is coupled adjacent to the screen box 402 based on a pressure change within the screen box 402 caused by the vacuum drawing air out of the removable drawer 124.

When the vacuum status determiner 208 determines that a vacuum is coupled to the vacuum system 125 and/or that a vacuum is drawing accumulated contaminants from the contaminant filter 127, the contaminant filter actuation controller 210 causes the contaminant filter 127 to actuate and/or move to encourage contaminants to dislodge from the contaminant filter 127 and/or to encourage any contaminants spaced from the vacuum system 125 to move toward the vacuum system 125 (block 914). While the contaminant filter actuation controller 210 causes the contaminant filter 127 to oscillate, the timer 212 monitors an amount of time that has elapsed since the maintenance event began (block 916) and the maintenance procedure controller 130 ends the maintenance event once the amount of time satisfies a threshold and/or once a threshold amount of the contaminants are removed and/or substantially removed from the contaminant filter 127 (block 918). In some examples, removing the threshold amount of the contaminant enables a desired flow rate through the contaminant filter 127 to be achieved.

The program of FIG. 10 begins at block 1002 with the maintenance event determiner 202 determining if a maintenance event should occur (block 1002). In some examples, the maintenance event determiner 202 determines that a maintenance event should occur if a threshold amount of time has elapsed, if a threshold amount of agent has been dispensed from the nozzles 120, if a threshold amount of build material has been distributed by the build material dispenser 110 and/or if a threshold number of objects have been produced by the printer 100 and, more generally, if a threshold amount of contaminant has accumulated within the printer 100.

If the maintenance event determiner 202 determines to perform a maintenance event, the maintenance event begins (block 1004) and the contaminant filter actuation controller 210 actuates the contaminant filter 127 to cause contaminants on the contaminant filter 127 to move toward the outlet and/or the port 318 to enable the contaminants to be removed from the contaminant filter 127 (block 1006). In some examples, the contaminant filter 127 is coupled to the removable drawer 124. In some examples, the contaminants are removed from build material used during an additive manufacturing process.

FIG. 11 is a block diagram of an example processor platform 1100 capable of executing the instructions of FIGS. 9 and 10 to implement the maintenance procedure controller 130 of FIGS. 1 and/or 2. The processor platform 1100 can be, for example, a server, a personal computer, a mobile device (e.g., a cell phone, a smart phone, a tablet), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by an integrated circuit(s), a logic circuit(s), a microprocessor(s) or a controller(s) from any desired family or manufacturer. The hardware processor may be a semiconductor based (e.g., silicon based) device. In this example, the processor implements the maintenance procedure controller 130, the maintenance event determiner 202, the alerter 204, the scheduler 206, the vacuum status determiner 208, the processor 134, the controller 106, the contaminant filter actuation controller 210, and the timer 212.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, an input device(s) 1122 is connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

An output device(s) 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes a mass storage device(s) 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 of FIGS. 9 and 10 may be stored in the mass storage device 1128, in the volatile memory 1114, in the non-volatile memory 1116, and/or on a removable tangible computer readable storage medium such as a CD or DVD.

From the foregoing, it will be appreciated that example methods, apparatus and articles of manufacture have been disclosed that increase the ease with which contaminants can be filtered out of and/or removed from build material used in connection with additive manufacturing systems including, for example, build material recovery systems. In some examples, to remove contaminants from the example build material recovery systems and/or, more generally, the example printers disclosed herein, a vacuum is couplable to a port to enable the contaminants to be drawn out of the port. In some examples, to further encourage the contaminants to be removed from the filter and/or to move the contaminants toward the vacuum, the drawer includes an actuator and/or oscillatory system that moves the filter as an example maintenance event is taking place. The oscillatory system may include a screen box including the filter that is coupled to a drawer of the build material recovery system via springs. In some examples, to further enable the accumulated contaminants to be removed from the build material recovery system and, more generally, the example printers disclosed herein, the filter and the associated screen box are coupled to the removable drawer.

In some examples, the drawer is removable by lifting a handle to disengage a first coupling and by rotating an example latch assembly relative to a pivot to disengage a second coupling. The first coupling may be at a first end and/or the top of the latch assembly and the second coupling may be at a second and/or the bottom of the latch assembly. The first coupling may include a latch that forms the first coupling when engaging on a bar and/or catch. The second coupling may include opposing first and second of protrusions and notches where the first notch receives the first protrusion and the second notch receives the second protrusion. In some examples, the first coupling is formed on both sides of the latch assembly and the second coupling is formed on both sides of the latch assembly. In other words, the first coupling may include two latches, one on a first side of the latch assembly and one on the second side of the latch assembly and the second coupling may include two sets of first and second of protrusions and notches, with one of the sets being on the first side of the latch assembly and the other one of the sets being on the second side of the latch assembly.

An example printer, comprising: a build material dispenser to dispense build material onto a work area; a contaminant filter to receive at least some of the build material from the work area, the contaminant filter being structured to filter contaminants from the build material received; and a drawer including the contaminant filter, the drawer to enable the contaminant filter to be removed for cleaning.

In the above example(s) or other examples, the printer may further include a build material recovery system including the contaminant filter, the drawer, and a hopper, the hopper to receive the build material that passes through the contaminant filter.

In the above example(s) or other examples, the drawer may further include a latch assembly to enable the drawer to be secured relative to the hopper when the drawer is positioned within the build material recovery system.

In the above example(s) or other examples, the latch assembly may include a first coupling and a second coupling, the first coupling formed based on an interaction between a latch of the drawer and a bar of the build material recovery system, the second coupling formed based on an interaction between a protrusion of one of the drawer or the build material recovery system and a notch of the other of the drawer or the build material recovery system.

In the above example(s) or other examples, the latch assembly may include a handle and a pivot, the handle structured to disengage the latch from the bar, the pivot structured to disengage protrusion from the notch to enable the drawer to be removed.

In the above example(s) or other examples, the printer may further include an actuator to actuate the contaminant filter during a maintenance event to encourage contaminants accumulated on the contaminant filter to be removed.

In the above example(s) or other examples, the printer may further include a frame to which the contaminant filter is coupled, the frame coupled to the drawer via springs to enable the frame and the contaminant filter to be responsive to the actuator.

In the above example(s) or other examples, the printer may include a port coupled to a nozzle, the nozzle being adjacent the contaminant filter when the contaminant filter is disposed within the printer, the nozzle positioned to enable the contaminants to be drawn through the nozzle and out of the port when the nozzle is coupled to a vacuum.

An example method, comprising determining, by executing an instruction with at least one processor, to perform a maintenance event on a printer; and in response to determining to perform the maintenance event on the printer, actuating a contaminant filter to cause contaminants on the contaminant filter to move toward an outlet, the contaminant filter being coupled to a removable drawer, the contaminants being removed from build material used during an additive manufacturing process.

In the above example(s) or other examples, the method may further include determining a status of a vacuum at the outlet, the vacuum to draw the contaminants out of the outlet.

In the above example(s) or other examples, the status of the vacuum may include the vacuum being coupled to the outlet.

In the above example(s) or other examples, after or before the maintenance event, the method may further include depositing the build material on a work area, selectively depositing agent from a nozzle onto the build material, and applying energy to the build material to selectively fuse the build material on which the agent has been deposited.

An example apparatus, comprising: a maintenance event determiner to determine to perform a maintenance event on a printer, the maintenance event including removing contaminants from a filter, the contaminants being removed from build material used during an additive manufacturing process; a scheduler to schedule the maintenance event to be performed based on the maintenance event determiner determining to perform the maintenance event; and a contaminant filter actuation controller to actuate the filter during the maintenance event to encourage the contaminants to be removed from the filter.

In the above example(s) or other examples, the apparatus may further include a timer to determine an amount of time elapsed since the maintenance event begins and to cause the maintenance event to end when the determined amount of time satisfies a threshold.

In the above example(s) or other examples, the apparatus may further include a build material dispenser to cause the build material to be deposited on a work area, an agent dispenser to selectively cause agent to be deposited from a nozzle onto the build material, and an energy source to cause energy to be applied to the build material to selectively fuse the build material on which the agent has been deposited.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A printer, comprising:
a build material dispenser to dispense build material onto a work area;
a contaminant filter to receive at least some of the build material from the work area, the contaminant filter being structured to filter contaminants from the build material received; and
a drawer including the contaminant filter, the drawer to enable the contaminant filter to be removed for cleaning.

2. The printer of claim 1, further including a build material recovery system including the contaminant filter, the drawer, and a hopper, the hopper to receive the build material that passes through the contaminant filter.

3. The printer of claim 2, wherein the drawer includes a latch assembly to enable the drawer to be secured relative to the hopper when the drawer is positioned within the build material recovery system.

4. The printer of claim 3, wherein the latch assembly includes a first coupling and a second coupling, the first coupling formed based on an interaction between a latch of the drawer and a bar of the build material recovery system, the second coupling formed based on an interaction between a protrusion of one of the drawer or the build material recovery system and a notch of the other of the drawer or the build material recovery system.

5. The printer of claim 4, wherein the latch assembly includes a handle and a pivot, the handle structured to disengage the latch from the bar, the pivot structured to disengage protrusion from the notch to enable the drawer to be removed.

6. The printer of claim 1, further including an actuator to actuate the contaminant filter during a maintenance event to encourage contaminants accumulated on the contaminant filter to be removed.

7. The printer of claim 6, further including a frame to which the contaminant filter is coupled, the frame coupled to the drawer via springs to enable the frame and the contaminant filter to be responsive to the actuator.

8. The printer of claim 1, further including a port coupled to a nozzle, the nozzle being adjacent the contaminant filter when the contaminant filter is disposed within the printer, the nozzle positioned to enable the contaminants to be drawn through the nozzle and out of the port when the nozzle is coupled to a vacuum.

9. A method, comprising:
determining, by executing an instruction with at least one processor, to perform a maintenance event on a printer; and
in response to determining to perform the maintenance event on the printer, actuating a contaminant filter to cause contaminants on the contaminant filter to move toward an outlet, the contaminant filter being coupled to a removable drawer, the contaminants being removed from build material used during an additive manufacturing process.

10. The method of claim 9, further including determining a status of a vacuum at the outlet, the vacuum to draw the contaminants out of the outlet.

11. The method of claim 10, wherein the status of the vacuum includes the vacuum being coupled to the outlet.

12. The method of claim 9, after or before the maintenance event, further including depositing the build material on a work area, selectively depositing agent from a nozzle onto the build material, and applying energy to the build material to selectively fuse the build material on which the agent has been deposited.

13. An apparatus, comprising:
a maintenance event determiner to determine to perform a maintenance event on a printer, the maintenance event including removing contaminants from a filter, the contaminants being removed from build material used during an additive manufacturing process;
a scheduler to schedule the maintenance event to be performed based on the maintenance event determiner determining to perform the maintenance event; and
a contaminant filter actuation controller to actuate the filter during the maintenance event to encourage the contaminants to be removed from the filter.

14. The apparatus of claim 13, further including a timer to determine an amount of time elapsed since the maintenance event begins and to cause the maintenance event to end when the determined amount of time satisfies a threshold.

15. The apparatus of claim 13, further including a build material dispenser to cause the build material to be deposited on a work area, an agent dispenser to selectively cause agent to be deposited from a nozzle onto the build material, and an energy source to cause energy to be applied to the build material to selectively fuse the build material on which the agent has been deposited.
